(19) United States
(12) Patent Application Publication
(10) Pub. No.: US 2020/0186383 A1
(43) Pub. Date: Jun. 11, 2020

(54) NETWORKING DEVICE AS DATA SERVER FOR CONNECTED IOT DEVICES

(71) Applicant: HEWLETT PACKARD ENTERPRISE DEVELOPMENT LP, Houston, TX (US)

(72) Inventors: Celestian K. Sebastian, Bangalore (IN); Anil Raj, Bangalore (IN); Srijith Ponnappan, Bangalore (IN); Anil Thomas, Bangalore (IN)

(21) Appl. No.: 16/213,448

(22) Filed: Dec. 7, 2018

(51) Int. Cl. H04L 12/28; H04L 29/08

(52) U.S. Cl. CPC H04L 12/2836; H04L 12/2823; H04L 12/2832; H04L 67/12

(57) ABSTRACT

According to one aspect of the disclosure, a computing system including at least one networking device with at least one processor and memory. The at least one processor executes instructions stored in the memory to collect data from one or more Internet of Things (IoT) devices via a first communication protocol and provide access to the collected data by one or more user devices via a second and different communication protocol. Further, the one or more IoT devices are communicatively coupled to the at least one networking device to sense the data and transmit the data to the at least one networking device, and the one or more user devices are communicatively coupled to the at least one networking device.

### BACKGROUND

The Internet of Things (IoT) provides for internetworking of physical devices that may have sensors and actuators, as well as network connectivity and processing logic to gather, process, and exchange data therebetween and/or with a networked element. For example, IoT devices may be heat sensors, smart light bulbs, smart kitchen devices, printers, cameras, and any other smart devices having embedded therein a computing system that enables these smart devices to connect and exchange data over a computing network. This capability provides for sensing by and/or remote control of devices across a network infrastructure, which leads to direct integration of the physical world with a digital infrastructure. The IoT devices sense data and update stored data either periodically or when there is a change in the sensed data, e.g., a change that causes the observed value of the data to be above/below a threshold or equal to a particular predefined value. The direct integration of IoT devices and the distribution thereof often entails reduced power consumption and, likewise, reduced processor speed and/or power. Accordingly, IoT devices may communicate with a network using simplified communication protocols or communication protocols otherwise adapted to the reduced processing power available from a particular IoT device. A system, apparatus, and/or method that accounts for a number of simplified communications protocols implemented across another number of IoT devices represents an advancement in the art.

The description provided in the background section should not be assumed to be prior art merely because it is mentioned in or associated with the background section. The background section may include information that describes one or more aspects of the subject technology.

### BRIEF DESCRIPTION OF THE DRAWINGS

The following detailed description references the drawings, wherein:

FIG. 1 is a diagram illustrating an example system architecture for facilitating communications between a network device, one or more IoT devices, and one or more a user devices;

FIG. 2 is a block diagram illustrating example IoT, network device, network controller, and user devices from the example network architecture of FIG. 1;

FIG. 3A is a diagram illustrating an example system architecture comprising a network switch, access point, and temperature sensors;

FIG. 3B is a diagram illustrating an example system architecture comprising an access point, one or more IoT devices, and one or more a user devices; and

FIG. 4 is a flowchart depicting aggregation of information according to an example aspect of the present disclosure.

Throughout the drawings, identical reference numbers may designate similar, but not necessarily identical, elements. Use herein of a reference numeral without an index number, where such reference numeral is referred to elsewhere with an index number, may be a general reference to the corresponding plural elements, collectively or individually. In one or more implementations, not all of the depicted components in each FIG. may be required, and one or more implementations may include additional components not shown in a FIG. Variations in the arrangement and type of the components may be made without departing from the scope of the subject disclosure. Additional components, different components, or fewer components may be utilized within the scope of the subject disclosure.

### DETAILED DESCRIPTION

As noted hereinabove, physical devices, which may comprise sensors, actuators, processing elements, and/or network communication elements, process and exchange data therebetween and/or with a networked element, which may comprise a network switch and/or switch controller to form the IoT network. Example embodiments may also include an access point, data aggregating device, a data analyzing device, and/or another networking device. The network capabilities of IoT devices allow objects to be sensed and controlled remotely across a network infrastructure. IoT devices are frequently used in agriculture, environment monitoring, infrastructure management, irrigation, manufacturing, medical and healthcare industries, smart building and home automation, transportation, and/or many other suitable fields.

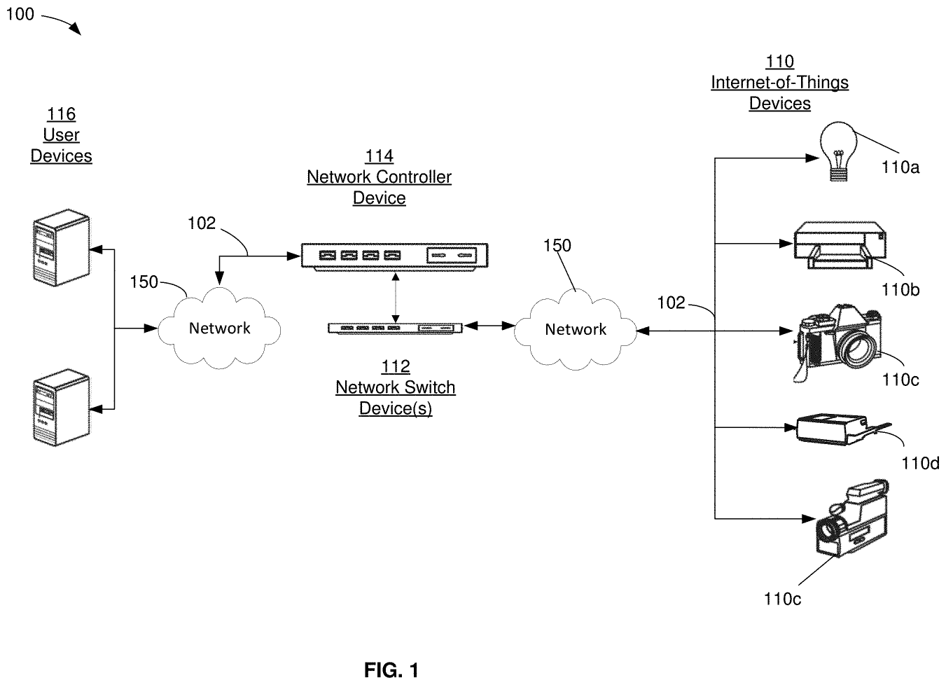

IoT devices may varying considerably in size. As illustrated in FIG. 1, IoT devices may include, for example, printers, cameras, and/or smart light bulbs. Further examples of IoT devices include medical implants, mobile phones, refrigerators, and/or any other suitable networked device. Just as the size of IoT devices may vary considerably, power and processing components of IoT devices are similarly variable. Numerous IoT devices may comprise a low power/battery power source and/or reduced processing power (e.g. throughput, clock rate, etc.). These reduced power and/or processing capabilities of certain IoT devices limits the abilities thereof when interacting with a computer or a data-collecting computing device.

Many information-carrying protocols, e.g. Simple Network Management Protocol (SNMP), REpresentational State Transfer (REST), etc., are commonly implemented to collect data from distributed computing resources. Following collection of said data, a wrapper program/function may plot the collected data in a format that is useful for a user. However, implementing information-carrying protocols on IoT devices that have reduced power and/or processing capabilities represents a challenge within the field. This disclosure contemplates a system and/or method for converting a networking device (e.g. switch, router, access point, etc.) for use as a data server thereby enhancing the data communications between IoT devices and a user device available to an end-user.

FIG. 1 illustrates an example architecture of system 100 for enhancing data communications between IoT devices 110 over a network 150. The system 100 includes the IoT devices 110, a network switch device/network device 112, a network controller device 114, and one or more user devices 116 connected over the network 150.

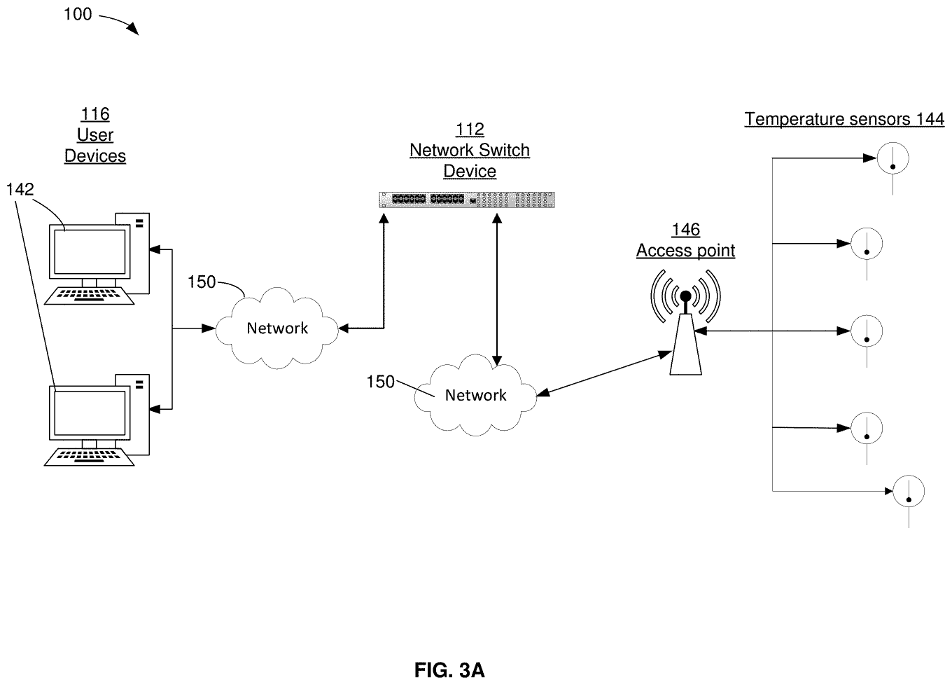

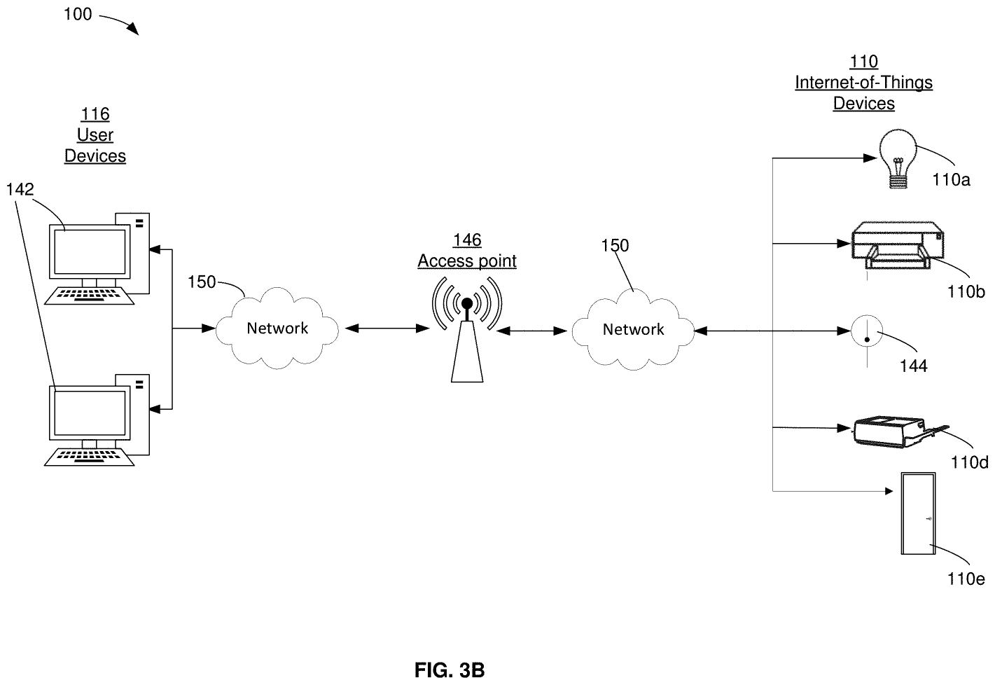

The IoT devices 110 may include heat sensors, smart light bulbs, smart kitchen devices, printers, cameras, and any other suitable smart devices having embedded therein a computing system that enables these smart devices to connect with and exchange data over a computing network. In FIG. 1, the IoT devices 110 include a smart light bulb 110a, a printer 110b, smart cameras and/or camcorders 110c, and a scanner 110d. The present examples also contemplate other IoT devices such as temperature sensors 144 and smart home devices 110e (see FIGS. 3A and 3B). The IoT devices 110 may sense data or otherwise interact with the IoT environment proximal each device. Further, the IoT devices may sense, detect, and/or recognize data concerning the operation of the IoT device 110.

For example, the smart light bulb 110a may sense and/or transmit data regarding when the light bulb is emitting light, the amount of power used, the time of day use occurs, and/or other information. The printer 110b may sense and/or transmit data concerning network usage, devices utilizing the printer, maintenance requirements, ink levels, past/present/future printing instructions, and/or other information. Further, the smart camera(s) 110c may sense and/or transmit data concerning, for example, image data, ambient light, available on-device storage, location information, user information, and/or other information. Still further, the scanner 110d, may sense and/or transmit example information including maintenance requirements, typical usage, future/scheduled use, user information, information drawn from scanned documents, and/or other information. The smart home devices 110e may transmit audio/video data, status information (open/closed), access information, user information, and/or other information. In these example IoT devices 110, information may be sensed continuously during use, at particular intervals, and/or when use and/or sensed information reaches a threshold level (e.g. the printer 110b may only sense and/or transmit an ink level when such level is below a threshold). Further, the example IoT devices 110 may transmit information when storage available on such devices is full, when polled by the network switch device(s) 112, or when requested by an end-user.

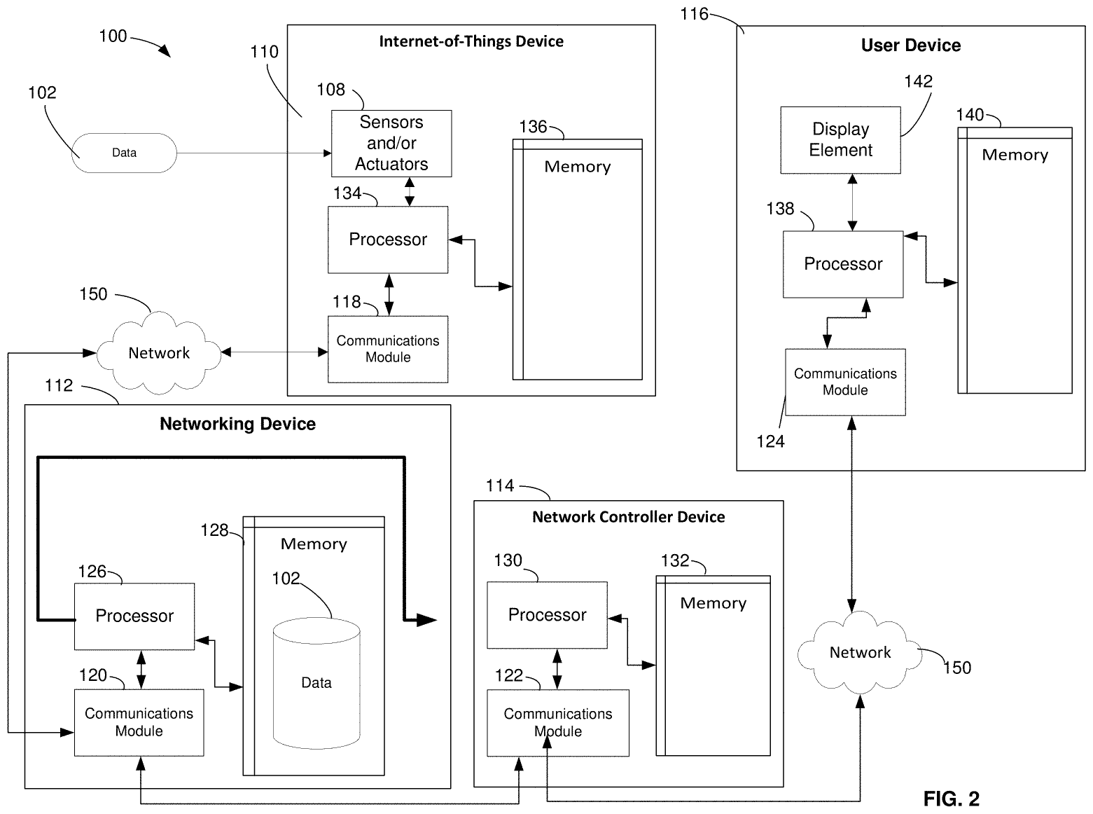

FIG. 2 is a block diagram illustrating an example device of the IoT devices 110, the networking device 112, which may comprise a network switch, wireless access point, a data aggregator, and/or another suitable device, the network controller device 114, and an example of the user device(s) 116, which form a part of the example architecture of the system 100 shown in FIG. 1, according to certain aspects of the disclosure.

The network switch device 112 facilities communication with the one or more IoT devices 110. The network switch device 112 may also aggregate the data 102 received from the IoT devices 110. Accordingly, the network switch device 112 may store data 102 received from the IoT devices 110 and/or may perform analysis of the data 102. One or more network switch devices 112 may be associated with the system and/or method 100. For example, a number of IoT devices 110 may be associated with a first network switch device while another number of IoT devices 110 may be associated with another network switch device. According to examples, the network switch device(s) 112 may transmit the data 102 (or a subset, aggregation, derivative, and/or variant of the data 102) to the network controller device 114.

The network controller device 114 may operate the network 150 facilitating communications between the user devices 116, network switch device(s) 112, and/or the IoT devices 110. For example, the network controller device 114 may implement sophisticated network protocols for communication with the user device(s) 116. Additionally, the network controller device 114 may aggregate the data 102 sensed and transmitted by the IoT devices 110 through the network switch devices(s) 112. For example, the network controller device 114 may aggregate the data 102 collected by one or more of the network switch device(s) 112. The network controller device 114 may perform processing and analysis of the data 102 (or a subset, aggregation, derivative, and/or variant of the data 102). The network controller device 114 may transmit to the user device(s) 116 the data 102 (or a subset, aggregation, derivative, and/or variant of the data 102) collected from the IoT devices 110. Further, the network controller device 114 may receive inquiries and/or instructions from the user device(s) 116. The network controller device 114 may further transmit these user inquiries and/or instructions to the network switch device(s) 112 and/or the IoT devices 110 (directly or indirectly through the network switch device(s) 112).

According to examples, the network switch device(s) 112 and/or the network controller device 114 may be replaced by one or more wireless access point 146 (see FIG. 3B) or another suitable device. Further, the network switch device(s) 112 and/or network controller 114 may operate to facilitate the network 150 to which the IoT devices 110 and the user device(s) 116 are connected. Additionally, the network switch device(s) 112 and the network controller 114 may operate on different networks. For example, the network switch device(s) 112 may facilitate a network optimized for the operability of the IoT devices 110 while a network facilitated by the network controller device 114 is optimized for operability of the user device(s) 116.

The IoT device(s) 110, the network switch device 112, the network controller device 114, and the user device(s) 116 are connected over the network 150 via respective communications modules 118, 120, 122, 124. The communications modules 118, 120, 122, 124 are configured to interface with the network 150 to send and receive information, such as data, requests, responses, and commands to other devices on the network. The communications modules 118, 120, 122, 124 may be, for example, modems, Ethernet cards, and/or wireless interfaces in compliance with various wireless standards, including but not limited to, Bluetooth, Zigbee, Wi-Fi, radio frequency identification (RFID), and/or near field communication (NFC).

The network switch device 112 includes a processor 126, the communications module 120, and a memory 128. The processor of the network switch device 112 is configured to execute instructions, such as instructions physically coded into the processor 126, instructions received from software stored in the memory 128, and/or a combination thereof. For example, the processor 126 of the network switch device 112 executes instructions to receive data originated from the IoT device(s) 110 and analyzes data packets of the received data. According to an example embodiment, the network switch device 112 executes instructions to implement a first communications protocol for communicating with a first IoT device 110a and a second communications protocol for communicating with a second IoT device 110b. The first communication protocol and the second communication protocol may be different. One or both of the first and second communications protocols may be optimized for low power and/or reduced processor performance. Accordingly, the network switch device 112 may operate as a data aggregator and enhance the data communications between the IoT device(s) 110 and the user device(s) 116 available to an end user.

The network controller device 114, for example a wireless local access network (WLAN) controller, includes a processor 130, the communications module 122, and a memory 132. The processor 130 of the network controller device 114 is configured to execute instructions, such as instructions physically coded into the processor 130, instructions received from software stored in the memory 132, instructions received from a remote module on a cloud infrastructure via communication module 122, or a combination thereof. For example, the processor 130 of the network controller 114 executes instructions, responsive to receiving a request from the network switch device 112 to transmit a port configuration to the network switch device 112 based on a communications protocol, such as the first or second communications protocols, used by the IoT device(s) 110. The processor 130 of the network controller device 114 also executes instructions to receive, from the network switch device 112, the data received from the IoT device(s) 110. Examples contemplated hereinthroughout may omit and/or replace the network controller device 114.

The IoT device(s) 110 comprise at least a processor 134, the communications module 118, a memory 136, and one or more sensors and/or actuators 108. The processor 134 of the example IoT device 110 is configured to execute instructions, such as instructions physically coded into the processor 130 and/or instructions received from software stored in the memory 136. For example, the processor 134 of the IoT device 110 executes instructions to operate the sensor and/or actuator 108 disposed within the IoT device 110 to gather data 102 concerning the environment surrounding the IoT device or to gather data 102 concerning the operation of the IoT device itself and implement a communications protocol such that the data 102 (or a subset, aggregation, derivative, and/or variant of the data 102) is transmitted by the communications module 118 of the IoT device 110 to the communications module 120 of the network switch device 112. The data 102 is transmitted over the network 150 illustrated in FIG. 2. Examples herein contemplate that each IoT device 110 may implement the same or different communications protocols such as, for example, wireless communications protocols in compliance with Bluetooth, Zigbee, Wi-Fi, radio frequency identification (RFID), near field communication (NFC), etc.

The user device(s) 116 include a processor 138, the communications module 124, a memory 140, and a display element 142. The processor 138 of the example user device 116 is configured to execute instructions, such as instructions physically coded into the processor 138, instructions received from software stored in memory 140, or a combination thereof. For example, the processor 138 of the example user device 116 executes instructions, responsive to a user request, such as through an input/output element (which can be an internal or external module of user device 116), for data 102 received from the one or more IoT device(s) 110. Note that in some examples, instead of requesting data 102 directly, the user device 116 may request a subset, an aggregation, a derivative, and/or a variant of the data 102. The processor 138 of the user device 116 may operate to output the data 102 and/or its subset, aggregation, derivative, and/or variant, by way of the display element 142, according to a user-friendly format, such as a graph, a plot, a chart, a table, an animation, a video clip, and/or any other visual representation. In some examples, such visual representation of the data 102 and/or its subset, aggregation, derivative, and/or variant may be presented through an augmented reality interface and layered upon other information based on data not gathered by the IoT devices 110.

Referring now to FIG. 3A, in an example embodiment of the system 100, the IoT device(s) 110 may comprise a number of the temperature sensors 144 deployed at various physical locations in a datacenter. The user device 116 may comprise a PC/terminal controlled by a datacenter administrator. The datacenter administrator may want to view the temperatures at one or more locations of the datacenter as sensed by the temperature sensors 144. Still further, it may be desirable for the datacenter administrator to receive an alert if the temperature of a particular region exceeds a threshold temperature (e.g., above 250 degrees Celsius). If the distributed temperature sensors 144 are relatively less complex, the raw data 102 collected by such temperature sensors 144 and received therefrom may not be particularly useful for the datacenter administrator. In particular, the datacenter administrator may not be able to easily use the PC/terminal to view the data 102 in a format that facilitates any effective analysis of the temperature of the particular region.

The temperature sensors of the IoT device(s) 110 use relatively basic communication protocols to transfer raw data to a data aggregator or access point 146 provided by the example datacenter administrator. To transport the temperature data to the user device 116 (e.g., PC/terminal) of the datacenter administrator, a management protocol, such as SNMP or REST may be implemented on the temperature sensors 144 (or IoT device(s) 110 in general). Note that many such management protocols exist and can be used in similar fashion without departing from the spirit of the instant disclosure. Further, many of these management protocols may not be supported by hardware available within the temperature sensors 144 (or IoT device(s) 110 in general). The above example may be expanded when many IoT device(s) 110, in addition to the temperature sensors 144, are present, such as may be the case in a smart building.

FIG. 3B shows an embodiment of the system and/or method 100 without the network switch device 112 deployed in system 100 of FIG. 3A. According to this example, the access point 146 operates as a data aggregator that aggregates data received from one or more IoT devices 110 via network 150 and enhances data communications between the IoT device(s) 110 and the user device(s) 116 available to an end user. Also, in this example embodiment, the IoT devices 110 may vary, as compared with FIG. 3A, to include IoT devices, other than temperature sensors, such as printers, cameras, smart light bulbs, home security devices, and/or other suitable IoT devices 110.

According to the system and/or method 100 shown in FIGS. 1 and 2, the data 102 is transferred to the network switch device 112 using a communication protocol available to each of the IoT devices 110, even if not available to all of the IoT devices 110. The network switch device 112 collects the raw data 102 from the IoT device(s) 110 and operates similar to a data server. The raw data 102 is stored in the memory 128 of the network switch device 112. The network switch device 112 is capable of communicating directly to the relatively sophisticated user device 116. The network switch device 112 operates as a data server collecting date from the IoT devices 110 and supplying that same, aggregated data to the user device 116 through the network controller device 114 when called upon by a user, such as the datacenter administrator of the previously detailed example. Therefore, management protocols are not implemented on the deployed sensors/IoT device(s) 110. This configuration enables the user device(s) 116 and an end user to leverage many available software and graphical tools to view the data in a fast, efficient, and informative format.

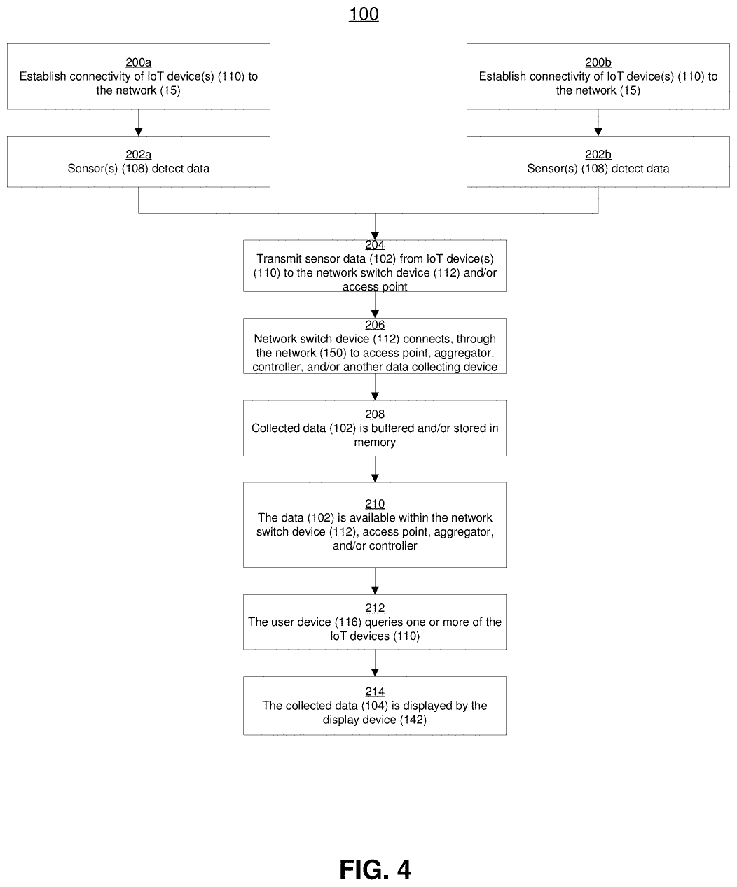

Referring now to FIG. 4, in steps 200a, 200b, the IoT device(s) 110 are deployed and activated. This step may include any number of sensors and therefore may give rise to any number of branches in FIG. 4. In steps 202a, 202b, sensors embedded in the IoT device(s) 110 monitor the environment of the IoT devices and/or the IoT devices themselves, and periodically transmit information to the network switch device 112. This information sharing may be implemented by any IoT-specific light weight data communication protocols, including but not limited to protocols specified in such standard specifications as Low-Power Wireless Personal Area Networks (6LoWPAN), Bluetooth Low Energy (BLE), IEEE 802.15.4, low power Wi-Fi, NFC, Sigfox, Low Power Wide Area Network (LoRaWAN), and/or another suitable data transfer protocol supported by the hardware of the IoT device(s) 110.

In step 204, the sensor data 102 is received by the network switch device 112. In another example embodiment, the data 102 may be received and collected by another IoT device comprising more sophisticated hardware and a robust power source, such that this IoT device is better capable of collecting and storing the information sent from many other IoT devices. In another example embodiment, the data 102 may be received and collected by the access point 146 (FIGS. 3A and 3B).

In step 206, the network 150 connects to an access point, an aggregator device, or a collecting IoT device through which the IoT device(s) 110 are communicatively connected to the network 150 by the network switch 112. By developing a communication protocol between the network switch and the aggregator device and/or access point 146 (FIG. 3A), the network device 112 may gather the data 102 from all the deployed IoT devices 110. Known management protocols, such as SNMP, REST, and/or another suitable protocol may facilitate communications between the aggregator device/access point 146 and the network device 112. Once the data is available within the network switch 112, at step 208, same data may be buffered as part of data capturing processes performed by the network switch 112. The amount of information that may be buffered is determined by the storage capacity of the network switch 112, and, therefore, is dependent upon the memory 128 of the network switch 112. Further, aggregating the data 102 may facilitate access to this information by decreasing the number of software applications through which different types of IoT devices are accessed. For example, different sensors developed by different equipment manufactures may provide access to sensed data through different, custom software interfaces. Therefore, aggregating all data may provide for simplified and more user-friendly access through a single software user interface.

An example embodiment may use the Open vSwitch Database Management Protocol (OVSDB), which is an OpenFlow configuration protocol that is designed to manage Open vSwitch implementations. Open vSwitch is a virtual switch that enables network automation, while supporting standard management interfaces and protocols. Open vSwitch also supports distribution across multiple physical servers. In an Open vSwitch implementation, a database server and a switch daemon are used. The OVSDB protocol is used in a control cluster, along with other managers and controllers, to supply configuration information to the switch database server. Controllers use OpenFlow to identify details of the packet flows through a switch. Each switch may receive directions from multiple managers and controllers, and each manager and controller can direct multiple switches. According to this embodiment, the data 102 may be added to a table within the Open vSwitch database server wherein the data 102 is saved chronologically and delivered to clients upon request.

At step 210, the data 102 is available within the network switch 112. Therefore, all of the resources and features of the network switch 112 may be extended on behalf of the IoT device(s) 110. As a result, at step 212, a relatively primitive IoT device may be queried for the current value thereof, or for stored historical values earlier captured, via an advanced protocol such as REST/SNMP that otherwise could not be supported by the IoT device 110 hardware. This increases the flexibility with which the user device(s) 116 may use and/or manipulate the data 102 captured by the IoT device(s) 110. Also, as the aggregated data 102 is stored in the network switch 112, analytics may be may be performed on the stored data 102. Accordingly, alerts and/or other monitoring functions may be triggered by changes in the monitored data as compared to the stored data 102. Such alerts/monitoring functions would be difficult for the sensors/IoT device(s) 110 to perform without the ability to store and to access the historical sensed data. At step 214, the data 102 from one or more of the IoT devices 110 is displayed by the display element 142 of the user device 116 in a user-friendly graphical and/or visual representation for viewing by an end user of the user devices.

The system and/or method for configuring the network switch device 112 to improve data communications between IoT devices 110 and user device(s) 116 provides for communications with the IoT device(s) 110 according to communications protocols that are suitable, or optimized, for implementation thereon. Configuration of the network switch device 112 as a data server for collection of the data 102 from the IoT device(s) 110 provides ease of access for the user device(s) 116 thereby facilitating faster and more meaningful manipulation of the data 102, such as for graphical presentation. Further, collecting of the data 102 by the network switch device 112 extends the functionality, from the perspective of an end user, of the network switch device 112 to each of the distributed, and often more hardware constrained, IoT device(s) 110. Recordation of the gathered data 102 in the network switch device 112 also allows for storage of historical data for the IoT device(s) 110. Storage of historical data and collection of current IoT data increases monitoring capabilities available to an end user through the user device(s) 116.

Processing elements 126, 130, 134, 138 may be, one or more central processing unit (CPU), one or more semiconductor-based microprocessor, one or more graphics processing unit (GPU), other hardware devices suitable for retrieval and execution of instructions stored in machine-readable storage medium 220, or combinations thereof. According to one aspect, the system architecture 100 is implemented using one or more special-purpose computing devices, such as low power IoT devices. The special-purpose computing device may be hard-wired to perform the disclosed techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques. The processors 126, 130, 134, 138 may be a general-purpose microprocessor, a microcontroller, a Digital Signal Processor (DSP), an ASIC, a FPGA, a Programmable Logic Device (PLD), a controller, a state machine, gated logic, discrete hardware components, or any other suitable entity that can perform calculations or other manipulations of information.

Machine-readable storage mediums/memories 128, 132, 136, 140 may be any electronic, magnetic, optical, or other physical storage device that contains or stores executable instructions. Thus, the machine-readable storage mediums/memories 128, 132, 136, 140 may be, for example, Random Access Memory (RAM), an Electrically Erasable Programmable Read-Only Memory (EEPROM), a storage drive, a Compact Disc Read Only Memory (CD-ROM), and the like. As described in detail herein, machine-readable storage mediums/memories 128, 132, 136, 140 may be encoded with a series of executable instructions for performing the functions and operations of the system/method 100 for configuring the network switch device 112 as a data server for the IoT device(s) 110.

While certain implementations have been shown and described above, various changes in form and details may be made. Furthermore, it should be appreciated that the systems and methods described herein can include various combinations and/or sub-combinations of the components and/or features of the different implementations described. Thus, features described with reference to one or more implementations can be combined with other implementations described herein.

The term “machine-readable storage medium” or “computer-readable medium” as used herein refers to any medium or media that participates in providing instructions or data to the processors 126, 130, 134, 138 for execution. The term “storage medium” as used herein refers to any non-transitory media that store data and/or instructions that cause a machine to operate in a specific fashion. Such a medium may take many forms, including, but not limited to, non-volatile media, volatile media, and transmission media. As used in this specification of this application, the terms “computer-readable storage medium” and “computer-readable media” are entirely restricted to tangible, physical objects that store information in a form that is readable by a computer. Furthermore, as used in this specification of this application, the terms “computer”, “server”, “processor”, and “memory” all refer to electronic or other technological devices. These terms exclude people or groups of people. For the purposes of the specification, the terms display or displaying means displaying on an electronic device.

What is claimed is:

1. A computing system comprising:
at least one networking device comprising at least one processor and memory, the at least one processor executing instructions stored in the memory to:
collect data from one or more Internet of Things (IoT) devices via a first communication protocol, and
provide access to the collected data by one or more user devices via a second and different communication protocol;
the one or more IoT devices communicatively coupled to the at least one networking device to sense the data and transmit the data to the at least one networking device; and
the one or more user devices communicatively coupled to the at least one networking device.

2. The computing system of claim 1, wherein the one or more IoT devices comprises first and second IoT devices.

3. The computing system of claim 2, wherein the first and second IoT devices are coupled to the at least one network switch by the first communication protocol and a third communication protocol, respectively.

4. The computing system of claim 3, wherein the networking device collects a first set of data from the first IoT device via the first communication protocol and a second set of data from the second IoT device via the third communication protocol; and
wherein the networking device provides access to both the first set of data and the second set of data to the one or more user devices via the second communication protocol.

5. The computing system of claim 3, wherein the first, second, and third communication protocols are selected from Bluetooth, Zigbee, Wi-Fi, Radio Frequency Identification (RFID), Near Field Communication (NFC), Simple Network Management Protocol (SNMP), Low-Power Wireless Personal Area Networks (6LoWPAN), Bluetooth Low Energy (BLE), IEEE 802.15.4, low power WiFi, Sigfox, Low Power Wide Area Network (LoRaWAN), and Representational State Transfer (REST).

6. The computing system of claim 2, wherein the networking device comprises at least one of a wireless access point and a network switch.

7. The computing system of claim 2, wherein the first communication protocol allows for low power consumption by the one or more IoT devices during operations.

8. The computing system of claim 2, wherein the networking device is configured to operate as a data server to serve the data collected from the one or more IoT devices upon requests from the one or more user devices.

9. The computing system of claim 8, wherein the data collected from the one or more IoT devices is stored over time to generate historical data.

10. The computing system of claim 8, wherein the networking device is configured to operate according to an OpenFlow configuration protocol.

11. The computing system of claim 8, wherein a display element presents the collected data in a graphical representation for viewing by an end user of the one or more user devices.

12. A data exchange method comprising:
establishing connectivity among one or more Internet of Things (IoT) devices in an IoT environment;
connecting the one or more IoT devices to a networking device over a first communication protocol;
wherein the one or more IoT devices sense data related to the IoT environment or the IoT devices;
transmitting the sensed data from the one or more IoT devices to the networking device over the first communication protocol;
storing the sensed data on a persistent memory of the networking device; and
serving to one or more user device at least one of the sensed data, a subset of the sensed data, an aggregation comprising the sensed data, a derivative from the sensed data, and a variant of the sensed data.

13. The method of claim 12, wherein the sensed data is aggregated by the networking device.

14. The method of claim 12, wherein the sensed data is aggregated over a period of time for at least one IoT device of the one or more IoT devices.

15. The method of claim 12, wherein the one or more IoT devices comprise a plurality of IoT devices; and
wherein the sensed data is aggregated within the memory of the networking device for the plurality of IoT devices.

16. The method of claim 12, further comprising:
configuring the networking device as a data server for aggregation of the sensed data.

17. A method of monitoring data comprising:
operating a networking device to collect sensed data by:
communicating with a first internet of things (IoT) device according to a first communications protocol;
communicating with a second IoT device according to a second communications protocol;
aggregating the sensed data from the first and second IoT devices;
communicating with a user device according to a third communications protocol to process the sensed data; and
wherein more computing resources are utilized by the user device to facilitate the third communication protocol as compared with either of the first and the second IoT devices respectively facilitating the first and the second communications protocols.

18. The method of claim 17, wherein the networking device is one of a network switch, an access point, and a network controller.

19. The method of claim 17, further comprising:
generating and displaying a graphical representation comprising at least one of the sensed data, a subset of the sensed data, an aggregation comprising the sensed data, a derivative from the sensed data, and a variant of the sensed data on a display element operatively coupled with the user device.

20. The method of claim 17, wherein the networking device is configured as a data server for providing access to at least one of the sensed data, a subset of the sensed data, an aggregation comprising the sensed data, a derivative from the sensed data, and a variant of the sensed data.
